(19) United States
(12) Patent Application Publication
(10) Pub. No.: US 2026/0052528 A1
(43) Pub. Date: Feb. 19, 2026

(54) SCHEDULING GROUPS FOR LOGICAL CHANNEL PRIORITIZATION

(71) Applicant: QUALCOMM Incorporated, San Diego, CA (US)

(72) Inventor: Linhai HE, San Diego, CA (US)

(21) Appl. No.: 19/240,376

(22) Filed: Jun. 17, 2025

Related U.S. Application Data
(60) Provisional application No. 63/683,117, filed on Aug. 14, 2024.

(51) Int. Cl. H04W 72/1263; H04L 47/52

(52) U.S. Cl. CPC H04W 72/1263; H04L 47/522

(57) ABSTRACT

Various aspects of the present disclosure generally relate to wireless communication. In some aspects, a user equipment (UE) may receive a scheduling configuration associated with a plurality of logical channel (LCH) scheduling groups. The UE may transmit data from at least one LCH in an LCH scheduling group, of the plurality of LCH scheduling groups, according to a priority policy that the scheduling configuration indicates for the at least one LCH scheduling group. Numerous other aspects are described.

### CROSS-REFERENCE TO RELATED APPLICATION

This Patent application claims priority to U.S. Provisional Patent Application No. 63/683,117, filed on Aug. 14, 2024, entitled “SCHEDULING GROUPS FOR LOGICAL CHANNEL PRIORITIZATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods for scheduling groups for logical channel prioritization.

### DESCRIPTION OF RELATED ART

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to an apparatus for wireless communication. The apparatus may include one or more memories and one or more processors coupled to the one or more memories. The one or more processors may be individually or collectively configured to receive a scheduling configuration associated with a plurality of logical channel (LCH) scheduling groups. The one or more processors may be individually or collectively configured to transmit data from at least one LCH in an LCH scheduling group, of the plurality of LCH scheduling groups, according to a priority policy that the scheduling configuration indicates for the at least one LCH scheduling group.

Some aspects described herein relate to an apparatus for wireless communication. The apparatus may include one or more memories and one or more processors coupled to the one or more memories. The one or more processors may be individually or collectively configured to transmit a scheduling configuration associated with a plurality of LCH scheduling groups. The one or more processors may be individually or collectively configured to receive data from at least one LCH in an LCH scheduling group, of the plurality of LCH scheduling groups, according to a priority policy that the scheduling configuration indicates for the at least one LCH scheduling group.

Some aspects described herein relate to a method of wireless communication performed by a user equipment (UE). The method may include receiving a scheduling configuration associated with a plurality of LCH scheduling groups. The method may include transmitting data from at least one LCH in an LCH scheduling group, of the plurality of LCH scheduling groups, according to a priority policy that the scheduling configuration indicates for the at least one LCH scheduling group.

Some aspects described herein relate to a method of wireless communication performed by a network node. The method may include transmitting a scheduling configuration associated with a plurality of LCH scheduling groups. The method may include receiving data from at least one LCH in an LCH scheduling group, of the plurality of LCH scheduling groups, according to a priority policy that the scheduling configuration indicates for the at least one LCH scheduling group.

Some aspects described herein relate to a non-transitory computer-readable medium that stores a set of instructions for wireless communication by a UE. The set of instructions, when executed by one or more processors of the UE, may cause the UE to receive a scheduling configuration associated with a plurality of LCH scheduling groups. The set of instructions, when executed by one or more processors of the UE, may cause the UE to transmit data from at least one LCH in an LCH scheduling group, of the plurality of LCH scheduling groups, according to a priority policy that the scheduling configuration indicates for the at least one LCH scheduling group.

Some aspects described herein relate to a non-transitory computer-readable medium that stores a set of instructions for wireless communication by a network node. The set of instructions, when executed by one or more processors of the network node, may cause the network node to transmit a scheduling configuration associated with a plurality of LCH scheduling groups. The set of instructions, when executed by one or more processors of the network node, may cause the network node to receive data from at least one LCH in an LCH scheduling group, of the plurality of LCH scheduling groups, according to a priority policy that the scheduling configuration indicates for the at least one LCH scheduling group.

Some aspects described herein relate to an apparatus for wireless communication. The apparatus may include means for receiving a scheduling configuration associated with a plurality of LCH scheduling groups. The apparatus may include means for transmitting data from at least one LCH in an LCH scheduling group, of the plurality of LCH scheduling groups, according to a priority policy that the scheduling configuration indicates for the at least one LCH scheduling group.

Some aspects described herein relate to an apparatus for wireless communication. The apparatus may include means for transmitting a scheduling configuration associated with a plurality of LCH scheduling groups. The apparatus may include means for receiving data from at least one LCH in an LCH scheduling group, of the plurality of LCH scheduling groups, according to a priority policy that the scheduling configuration indicates for the at least one LCH scheduling group.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification, and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network.

FIG. 3 is a diagram illustrating an example disaggregated base station architecture in accordance with the present disclosure.

FIG. 4 is a diagram illustrating an example of a user plane protocol stack and a control plane protocol stack for a network node and a core network in communication with a UE, in accordance with the present disclosure.

FIG. 5 is a diagram illustrating an example of a mapping among uplink logical channels (LCHs), uplink transport channels, and uplink physical channels, in accordance with the present disclosure.

FIG. 6 is a diagram illustrating an example associated with LCH prioritization, in accordance with the present disclosure.

FIG. 7 is a diagram of an example associated with LCH prioritization for LCH scheduling groups, in accordance with the present disclosure.

FIG. 8 is a diagram illustrating an example associated with scheduling groups for LCH prioritization, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIGS. 11-12 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless network, a user equipment (UE) and a network node may each implement one or more protocol stacks (e.g., a user plane protocol stack and a control plane protocol stack) that include various protocol layers, such as a physical (PHY) layer, a medium access control (MAC) layer, and a radio link control (RLC) layer, among other examples. Information flows between different protocol layers, known as channels, may be used to segregate and transport different data types across different layers. Accordingly, the channels may provide interfaces between layers within the one or more protocol stacks and enable an orderly and defined data segmentation. For example, logical channels (LCHs) carry user data and signaling messages between the RLC layer and the MAC layer, transport channels carry user data and signaling messages between the MAC layer and the PHY layer, and physical channels carry user data and signaling messages between the UE and the network node. For example, in an uplink direction, uplink LCHs include a common control channel (CCCH) used to carry control information for multiple UEs, a dedicated control channel (DCCH) dedicated to carrying control information for a particular UE, and a dedicated traffic channel (DTCH) dedicated to carrying traffic for a particular UE, and uplink transport channels include an uplink shared channel (UL-SCH) that is used to carry uplink data and shared among the CCCH, DCCH, DTCH. Accordingly, in the uplink direction, the MAC layer performs an LCH prioritization procedure to control the manner in which UL-SCH resources are shared among different LCHs.

For example, when a UE is configured with multiple LCHs that share UL-SCH resources, a MAC layer at the UE may prioritize data from the LCHs according to respective LCH configurations that a network node sends or otherwise provides for the multiple LCHs. For example, the LCH configurations may be provided in one or more radio resource control (RRC) messages, where the parameters associated with each LCH configuration may include a priority (e.g., an integer from 1 to 16 or another suitable value, where 1 corresponds to a highest priority and 16 corresponds to a lowest priority), a prioritized bit rate (PBR) (e.g., a value in kilobytes per second (kBps)), and a bucket size duration (BSD) (e.g., a value in milliseconds). The PBR and the BSD associated with an LCH may parameterize a leaky bucket regulator associated with the LCH, which the MAC layer may use together with the configured priorities to schedule data associated with different LCHs according to a fair priority queuing policy. For example, each LCH is associated with a scheduling eligibility state variable, Bj, which is initialized to zero when the LCH is established. The state variable associated with each LCH is periodically updated (e.g., prior to each LCH prioritization) according to Bj=Bj+PBR×T, where T is a duration or time period since the value of Bj was most recently updated. If Bj has a value that exceeds a bucket size defined as PBR×BSD, the value of Bj is rounded down to the bucket size value.

Accordingly, when an uplink grant is available, the UE initially identifies one or more eligible LCHs (e.g., LCHs that have uplink data and Bj value greater than 0), and starts scheduling data from eligible LCHs according to a descending priority (e.g., from a highest priority to a lowest priority). For example, when scheduling data from an eligible LCH, the selected LCH is allocated enough resources to achieve the PBR associated with the LCH (e.g., a transmit buffer associated with the LCH is emptied by at least the value of Bj), and the state variable Bj for the LCH is then updated by subtracting the size of the scheduled data. If the selected LCH has a PBR with an infinite value, the transmit buffer associated with the LCH is emptied completely before serving any other LCH. In cases where the uplink grant has spare radio resources remaining after all eligible LCHs with a Bj value greater than 0 have been scheduled, the UE then schedules data from all LCHs according to a strict priority without regard to the Bj value (e.g., not limited to eligible LCHs only). In this way, the LCH prioritization may maximize throughput and provide relative delay performance across various LCHs that share UL-SCH resources.

However, although LCH prioritization provides acceptable performance for traffic having elastic priority requirements and for traffic having no hard delay requirements, the LCH prioritization procedure poses challenges as traffic become more diverse. For example, LCH prioritization provides only relative delay performance, which may fail to satisfy traffic requirements as traffic becomes more inelastic, with hard delay requirements. Additionally, delay-sensitive traffic is often characterized by a relative increase in traffic burst sizes (e.g., a larger maximum data burst volume (MBDV), which is generally defined as a maximum data burst that needs to be delivered within any given packet delay budget (PDB)), where prioritization of such bursts is an important aspect of network performance. Furthermore, although legacy LCH prioritization is designed to maximize throughput performance, low latency is also an important performance parameter in wireless network applications. For example, low latency may be important for applications that require real-time or near-real-time communications regardless of the size and/or number traffic bursts.

Various aspects generally relate to LCH prioritization using multiple scheduling policies applied between scheduling groups and within scheduling groups that are each composed of one or more LCHs. Some aspects more specifically relate to assigning each LCH to a scheduling group according to different scheduling group criteria. In some aspects, each scheduling group may be configured with a different scheduling policy. For example, a network node may configure a priority between different scheduling groups based on parameters applied to the LCHs in all scheduling groups. In some aspects, a network node may configure the scheduling policy applied to determine priority between scheduling groups.

For example, when an uplink grant is available, the UE may perform an LCH prioritization that includes a first phase in which the UE begins to schedule data from the LCH scheduling group with the highest priority and at least one eligible LCH. After scheduling the data from the eligible LCH(s) in the LCH scheduling group with the highest priority, and if a transport block (TB) still has available capacity, the UE may then schedule data from the LCH scheduling group with the next highest priority and having at least one eligible LCH. The first phase may continue this process according to the respective priorities of the LCH scheduling groups until no LCH scheduling group contains any eligible LCHs or until the TB is full, whichever occurs first. Following the first phase, the UE may perform an LCH prioritization according to a second phase in which strict priority scheduling (or another inter-group priority policy that may be configured) is applied to all non-empty LCHs until either all data has been included in the TB or until the TB is full.

Particular aspects of the subject matter described in this disclosure can be implemented to realize one or more of the following potential advantages. In some examples, by prioritizing LCHs using scheduling policies applied between and within scheduling groups composed of LCHs, the described techniques can be used to provide better support for delay sensitive traffic and low latency applications while retaining throughput performance. For example, different scheduling algorithms may be used for intra-group priority policies and/or for inter-group priority policies depending on the LCH type(s) and/or the application. For example, earliest deadline first (EDF) can be used to enforce hard deadlines when a link is not overloaded or when there are a small number of flows in a group. Similarly, fair priority queuing (FPQ) can be used to simplify priority scheduling by avoiding the resource-intensive process of sorting a large number of flows by respective deadlines. For example, FPQ may be used as an inter-group scheduling policy and EDF may be used as an intra-group scheduling policy, resulting in efficient sorting of priority between LCH scheduling groups, accurate enforcement of hard deadlines between LCHs in each scheduling group, and/or a fair bandwidth allocation among different scheduling groups based on respective priorities and PBRs. Furthermore, other suitable scheduling policies, such as first come first serve (FCFS), may be utilized depending on the most important performance parameter(s) for traffic associated with LCHs within a scheduling group.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

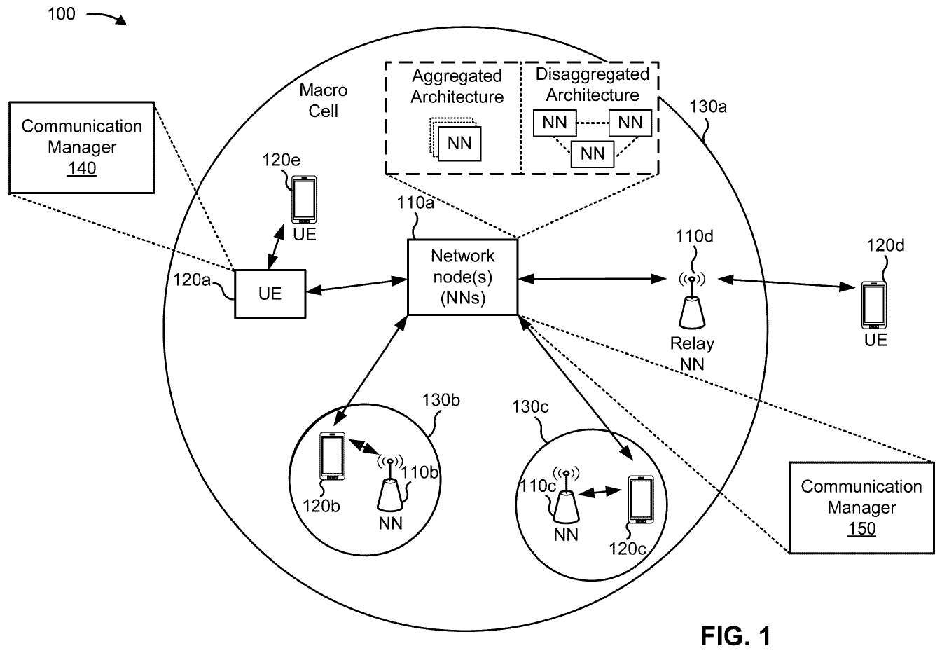

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as RRC functions, packet data convergence protocol (PDCP) functions, and/or service data adaptation protocol (SDAP) functions, among other examples. A DU may host one or more of an RLC layer, a MAC layer, and/or one or more higher PHY layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive a scheduling configuration associated with a plurality of LCH scheduling groups; and transmit data from at least one LCH in an LCH scheduling group, of the plurality of LCH scheduling groups, according to a priority policy that the scheduling configuration indicates for the at least one LCH scheduling group. Additionally, or alternatively, the communication manager 140 may perform one or more other operations described herein.

In some aspects, the network node 110 may include a communication manager 150. As described in more detail elsewhere herein, the communication manager 150 may transmit a scheduling configuration associated with a plurality of LCH scheduling groups; and receive data from at least one LCH in an LCH scheduling group, of the plurality of LCH scheduling groups, according to a priority policy that the scheduling configuration indicates for the at least one LCH scheduling group. Additionally, or alternatively, the communication manager 150 may perform one or more other operations described herein.

As indicated above, FIG. 1 is provided as an example. Other examples may differ from what is described with regard to FIG. 1.

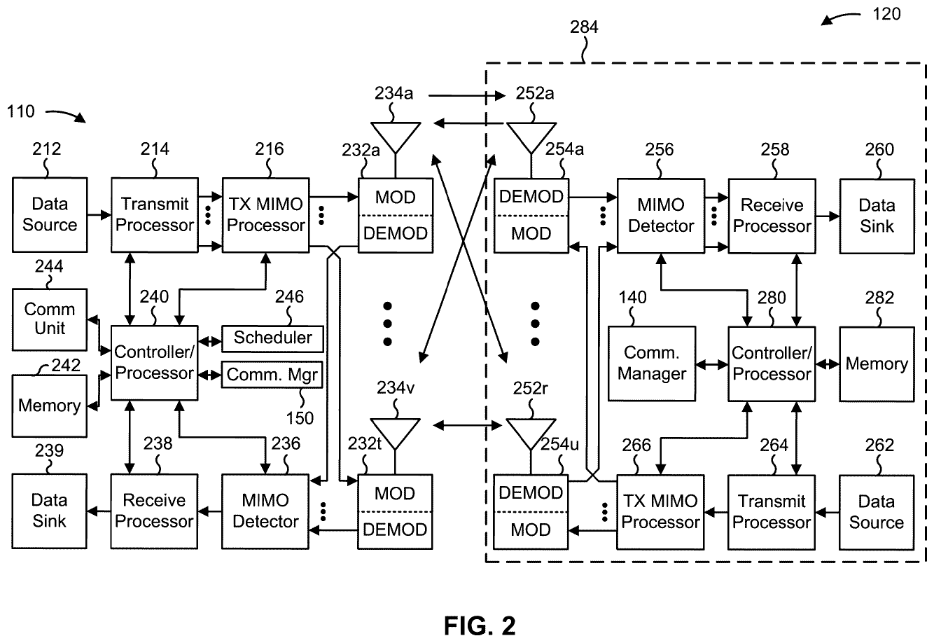

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more TBs of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

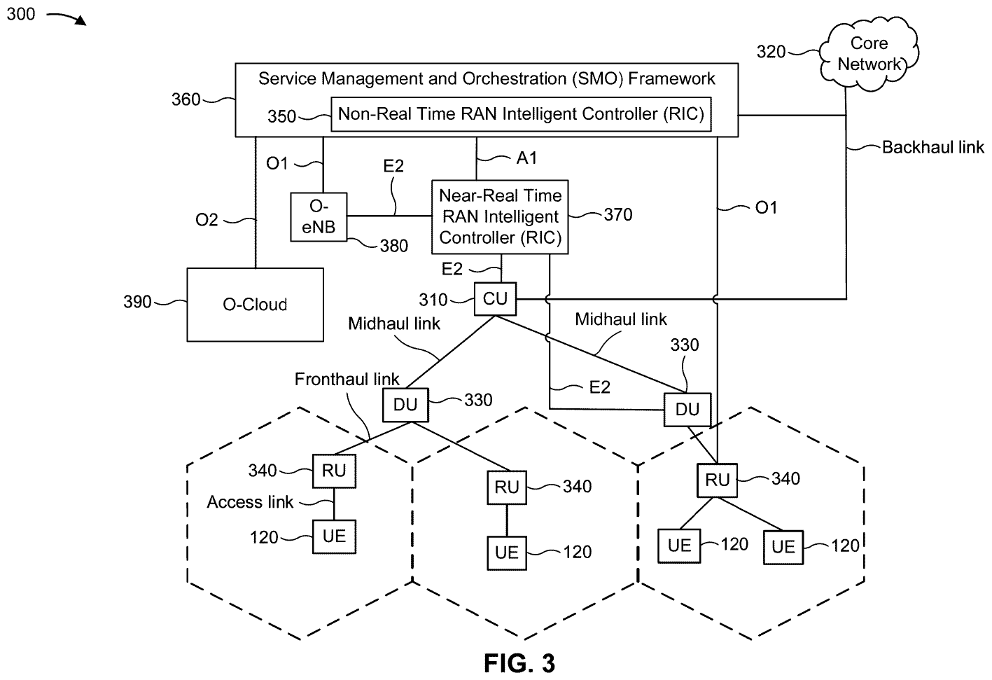

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

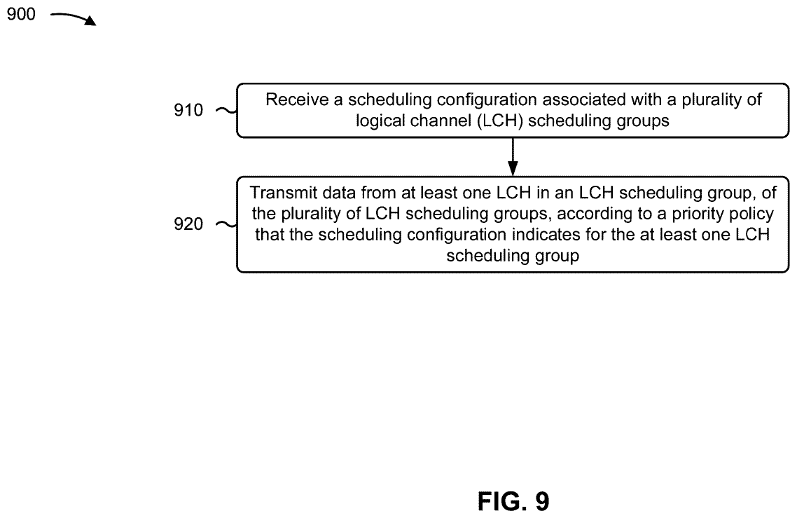

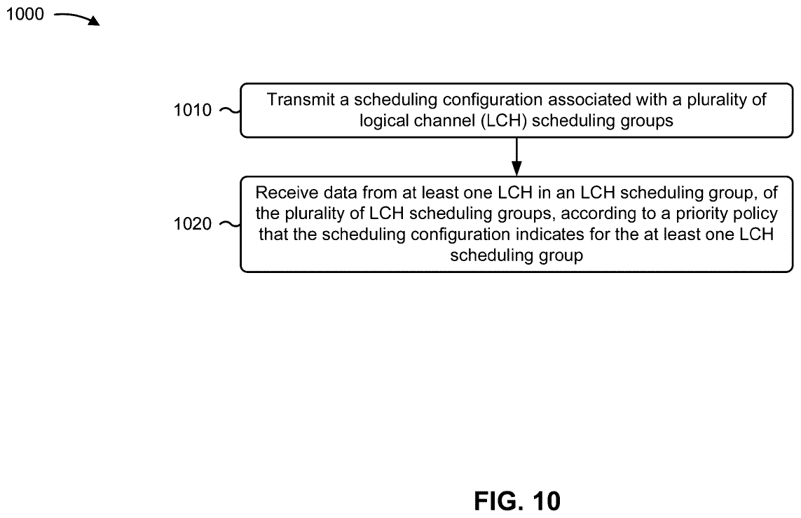

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with scheduling groups for LCH prioritization as described in more detail elsewhere herein. For example, the controller/processor 240 of the network node 110, the controller/processor 280 of the UE 120, any other component(s) (or combinations of components) of FIG. 2, the CU 310, the DU 330, or the RU 340 may perform or direct operations of, for example, process 900 of FIG. 9, process 1000 of FIG. 10, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, the UE 120 includes means for receiving a scheduling configuration associated with a plurality of LCH scheduling groups; and/or means for transmitting data from at least one LCH in an LCH scheduling group, of the plurality of LCH scheduling groups, according to a priority policy that the scheduling configuration indicates for the at least one LCH scheduling group. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a scheduling configuration associated with a plurality of LCH scheduling groups; and/or means for receiving data from at least one LCH in an LCH scheduling group, of the plurality of LCH scheduling groups, according to a priority policy that the scheduling configuration indicates for the at least one LCH scheduling group. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

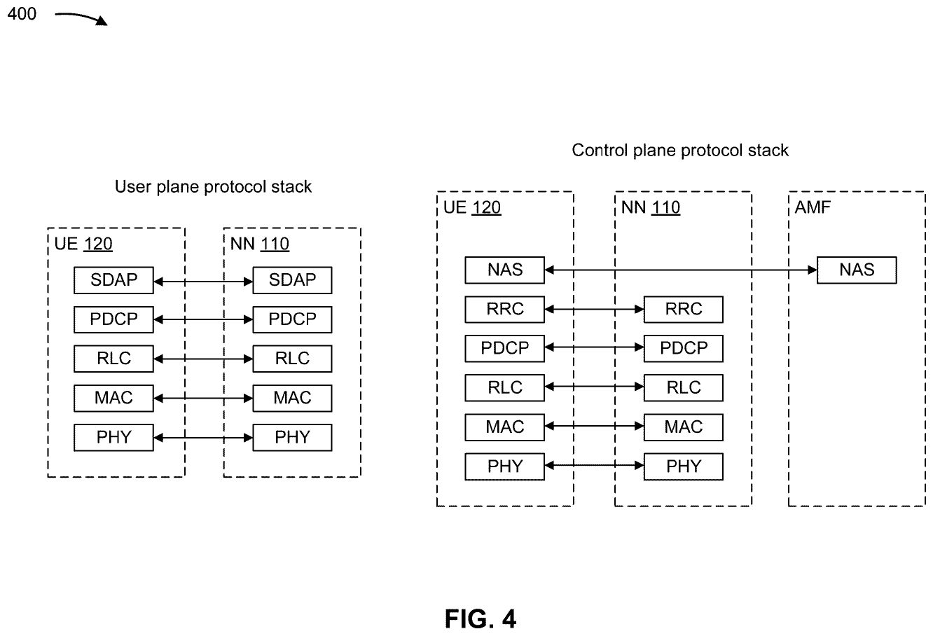

FIG. 4 is a diagram illustrating an example 400 of a user plane protocol stack and a control plane protocol stack for a network node 110 and a core network in communication with a UE 120, in accordance with the present disclosure. In some aspects, the network node 110 may include a plurality of network nodes 110. In some aspects, protocol stack functions of the network node 110 may be distributed across multiple network nodes 110. For example, a first network node 110 may implement a first layer of a protocol stack and a second network node 110 may implement a second layer of the protocol stack. The distribution of the protocol stack across network nodes (in examples where the protocol stack is distributed across network nodes) may be based at least in part on a functional split, as described elsewhere herein. It should be understood that references to “a network node 110” or “the network node 110” can, in some aspects, refer to multiple network nodes.

On the user plane, the UE 120 and the network node 110 may include respective PHY layers, MAC layers, RLC layers, PDCP layers, and SDAP layers. A user plane function (UPF) may handle transport of user data between the UE 120 and the network node 110. On the control plane, the UE 120 and the network node 110 may include respective RRC layers. Furthermore, the UE 120 may include a non-access stratum (NAS) layer in communication with an NAS layer of an AMF. The AMF may be associated with a core network associated with the network node 110, such as a 5G core network (5GC) or a next-generation radio access network (NG-RAN). A control plane function may handle transport of control information between the UE 120 and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 4, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE 120 and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (e.g., handover and context transfer, UE cell selection and reselection and control of cell selection and reselection, inter-RAT mobility); quality of service (QoS) management functions; UE measurement reporting and control of the reporting; detection of and recovery from radio link failure; and NAS message transfer between the NAS layer and the lower layers of the UE 120. The RRC layer is frequently referred to as Layer 3 (L3).

The SDAP layer, PDCP layer, RLC layer, and MAC layer may be collectively referred to as Layer 2 (L2). Thus, in some cases, the SDAP, PDCP, RLC, and MAC layers are referred to as sublayers of Layer 2. On the transmitting side (e.g., if the UE 120 is transmitting an uplink communication or the network node 110 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some aspects, the RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP service data units (SDUs), ciphering and deciphering, PDCP SDU discard (e.g., in accordance with a timer, as described elsewhere herein), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via automatic repeat requests (ARQ), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from TBs delivered to/from the PHY layer on transport channels, scheduling information reporting, error correction through hybrid ARQ (HARQ), priority handling between UEs 120 by dynamic scheduling, priority handling between LCHs of one UE 120 by LCH prioritization, and padding.

The MAC layer may package data from LCHs into TBs, and may provide the TBs on one or more transport channels to the PHY layer. The PHY layer may handle various operations relating to transmission of a data signal, as described in more detail in connection with FIG. 2. The PHY layer is frequently referred to as Layer 1 (L1).

On the receiving side (e.g., if the UE 120 is receiving a downlink communication or the network node 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to LCHs and may provide data to the RLC layer via the LCHs. The RLC layer may map the LCHs to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

As indicated above, FIG. 4 is provided as an example. Other examples may differ from what is described with regard to FIG. 4.

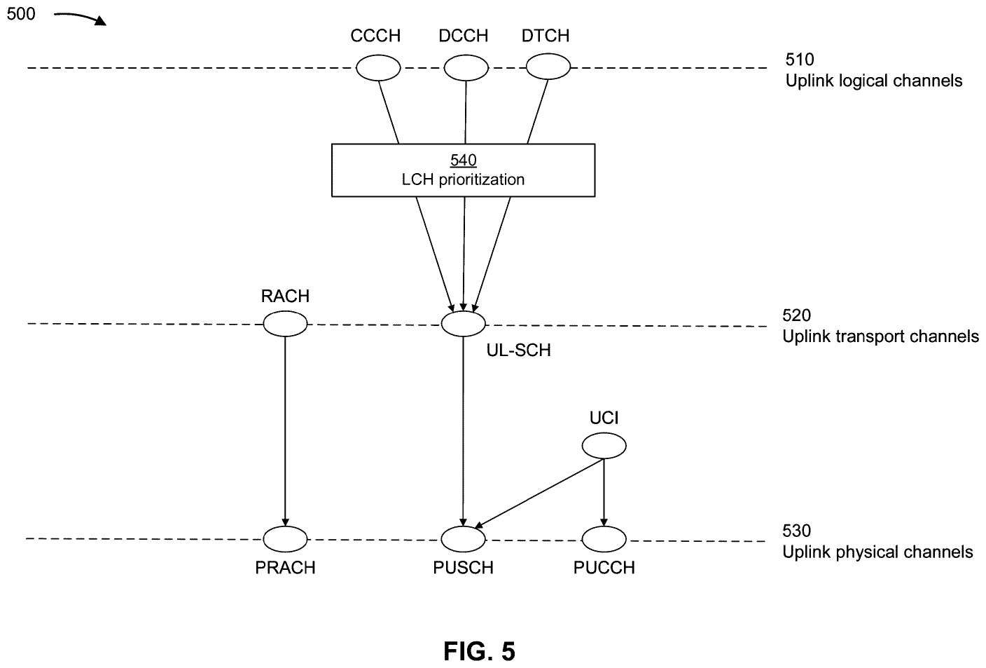

FIG. 5 is a diagram illustrating an example 500 of a mapping among uplink LCHs 510, uplink transport channels 520, and uplink physical channels 530, in accordance with the present disclosure. The uplink LCHs 510, the uplink transport channels 520, and the uplink physical channels 530 are implemented in a UE 120.

For example, as described herein, a UE 120 and a network node 110 may each implement one or more protocol stacks (e.g., a user plane protocol stack and a control plane protocol stack) that include various protocol layers, such as a PHY layer, a MAC layer, and an RLC layer, among other examples. Information flows between different protocol layers, known as channels, are used to segregate and transport different data types across different layers. Accordingly, the channels may provide interfaces between layers within the one or more protocol stacks and enable an orderly and defined data segmentation. For example, LCHs carry user data and signaling messages between the RLC layer and the MAC layer, transport channels carry user data and signaling messages between the MAC layer and the PHY layer, and physical channels carry user data and signaling messages between the UE 120 and the network node 110.

For example, as shown in FIG. 5, uplink LCHs 510 include a CCCH used to carry control information for multiple UEs 120, a dedicated DCCH dedicated to carrying control information for a particular UE 120, and a DTCH dedicated to carrying traffic for a particular UE 120. As further shown in FIG. 5, uplink transport channels 520 include an UL-SCH that is used to carry uplink data and a random access channel (RACH) used for a RACH procedure. As further shown in FIG. 5, the UL-SCH is shared among the CCCH, DCCH, DTCH. Furthermore, as further shown in FIG. 5, uplink physical channels 530 include a PRACH that is mapped to the RACH transport channel and serves as the physical channel through which a UE 120 initiates and/or synchronizes communication with a network node 110, a PUSCH that is mapped to the UL-SCH transport channel and used to carry uplink data from a UE 120 to a network node 110, and a PUCCH used to carry UCI or other control signaling (e.g., acknowledgements or negative acknowledgements for received data, buffer status reports (BSRs), scheduling requests (SRs), and/or CQI information, among other examples) from a UE 120 to a network node 110. In addition, as shown in FIG. 5, the PUSCH may carry UCI in some cases (e.g., UCI may be multiplexed with uplink user data in a PUSCH transmission).

As described herein, the UL-SCH is shared among the CCCH, DCCH, DTCH, whereby a MAC layer may perform an LCH prioritization procedure 540 in the uplink direction to control how UL-SCH resources are shared among different LCHs. For example, when a UE 120 is configured with multiple LCHs 510 that share UL-SCH resources, the MAC layer at the UE 120 may prioritize data from the LCHs 510 according to respective LCH configurations that a network node 110 sends or otherwise provides for the multiple LCHs 510. For example, the LCH configurations may be provided in one or more RRC messages, where the parameters associated with each LCH configuration may include a priority (e.g., an integer from 1 to 16 or another suitable value, where 1 corresponds to a highest priority and 16 corresponds to a lowest priority), a PBR (e.g., a value in kBps), and a BSD (e.g., a value in milliseconds). The PBR and the BSD associated with an LCH 510 may parameterize a leaky bucket regulator associated with the LCH 510, which the MAC layer uses together with the configured priorities to schedule data associated with different LCHs 510 according to a FPQ policy. For example, each LCH 510 is associated with a state variable, Bj, that relates to scheduling eligibility, where the state variable Bj is initialized to zero when an LCH 510 is established. The state variable associated with each LCH 510 is periodically updated (e.g., prior to each execution of the LCH prioritization procedure 540) according to Bj=Bj+PBR×T, where T is a duration or time period since the value of Bj was most recently updated. If Bj has a value that exceeds a bucket size defined as PBR×BSD, the value of Bj is rounded down to the bucket size value.

Accordingly, when an uplink grant is available, the UE 120 initially identifies one or more eligible LCHs 510 (e.g., LCHs 510 that have uplink data and Bj value greater than 0), and starts scheduling data from eligible LCHs 510 according to a descending priority (e.g., from a highest priority to a lowest priority). For example, when scheduling data from an eligible LCH 510, the selected LCH 510 is allocated enough resources to achieve the PBR associated with the LCH 510 (e.g., a transmit buffer associated with the LCH 510 is emptied by at least the value of Bj), and the state variable Bj for the LCH 510 is then updated by subtracting the size of the scheduled data. If the selected LCH 510 has a PBR with an infinite value, the transmit buffer associated with the LCH 510 is emptied completely before serving any other LCH 510. In cases where the uplink grant has spare radio resources remaining after all eligible LCHs 510 have been scheduled, the UE 120 then schedules data from all LCHs 510 according to a strict priority without regard to the Bj value (e.g., not limited to eligible LCHs 510). In this way, the LCH prioritization procedure 540 may maximize throughput and provide relative delay performance across various LCHs 510.

As indicated above, FIG. 5 is provided as an example. Other examples may differ from what is described with regard to FIG. 5.

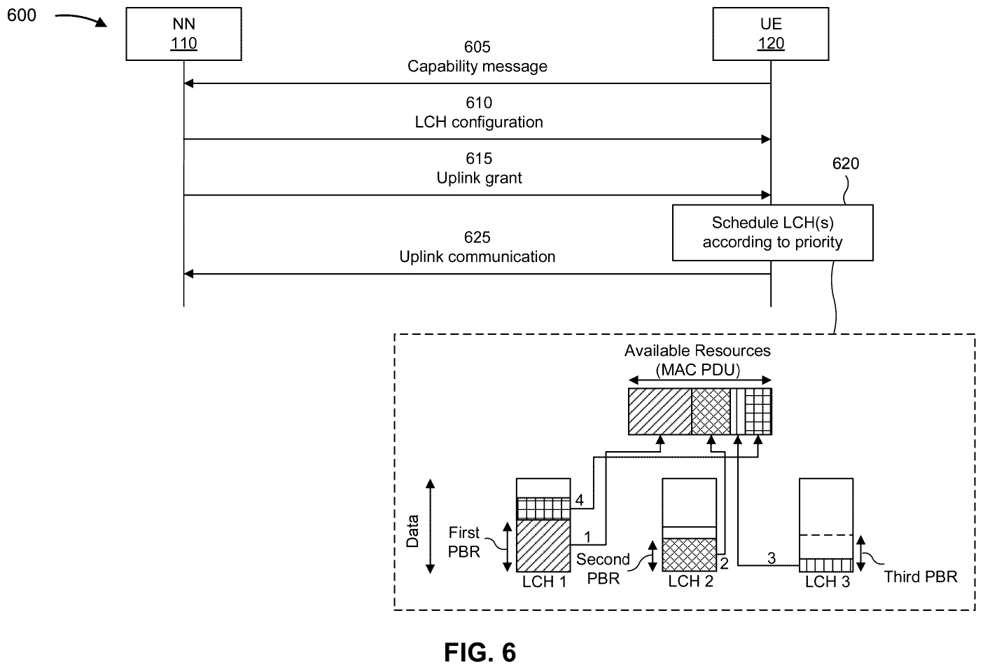

FIG. 6 is a diagram illustrating an example 600 associated with LCH prioritization, in accordance with the present disclosure. As shown in FIG. 6, a network node 110 and a UE 120 may communicate with one another (for example, via a wireless network, such as wireless network 100 of FIG. 1). The network node 110 may include an RU and/or a device controlling the RU, such as a DU and/or a CU. The network node 110 may be associated with at least one TRP (for example, within a cell).

In a first operation 605, the UE 120 may transmit, and the network node 110 may receive, a capability message indicating that the UE 120 is configured for or otherwise supports LCH restrictions. For example, the capability message may include a UECapabilityInformation message, as defined in 3GPP specifications. Accordingly, the UE 120 may indicate that the UE 120 is configured for LCH restrictions using an lcp-Restriction information element (IE), as defined, or otherwise fixed, by a wireless communication standard, such as the 3GPP. In some examples, the network node 110 may transmit, and the UE 120 may receive, a request for the capability message (for example, a UECapabilityEnquiry message, as defined, or otherwise fixed, by a wireless communication standard, such as the 3GPP). The UE 120 may transmit, and the network node 110 may receive, the capability message based on, in response to, or otherwise in association with the request.

In a second operation 610, the network node 110 may transmit, and the UE 120 may receive, a configuration that indicates at least one LCH restriction (e.g., for one or more LCHs in one or more sets or groups of LCHs). For example, in some aspects, the network node 110 may determine an LCH prioritization (LCP) for the UE 120. The network node 110 may determine priorities for respective LCHs. For example, each LCH may be associated with a priority. In some examples, the priority may be an integer value (for example, from 1 to 16, where 1 is a highest priority and 16 is a lowest priority). In some examples, the network node 110 may determine at least one restriction (for example, an LCP restriction) according to a QoS requirement associated with an LCH for the UE 120. As described herein, an LCH may generally reside between an RLC layer and a MAC layer and may facilitate downlink communications from the network node 110 to the UE 120 and/or may facilitate uplink communications from the UE 120 to the network node 110. An LCH may reside in the control plane and carry control information or may reside in the user plane and carry user data.

In one example, the network node 110 may identify delay-sensitive traffic (for example, traffic for an XR application). Accordingly, the network node 110 may determine a restriction for an LCH, to which the delay-sensitive traffic is assigned, that will route the delay-sensitive traffic to a physical channel (for example, to a TRP of the network node 110) with a higher data rate (for example, a lower data load). In another example, the network node 110 may identify error-sensitive traffic (for example, pose updates for an XR application). Accordingly, the network node 110 may determine a restriction for an LCH, to which the error-sensitive traffic is assigned, that will route the error-sensitive traffic to a TRP of the network node 110 with greater robustness (for example, higher quality and/or reliability). In another example, the network node 110 may identify an LCH associated with control information for the UE 120. Accordingly, the network node 110 may determine a restriction for the LCH, to which the control information is assigned, that will route the control information to a TRP of the network node 110 with greater robustness (for example, higher quality and/or reliability).

In some examples, an application service may be a multi-modal service. The multi-modal service may be associated with multi-modal traffic. As used herein, “multi-modal traffic” may refer to traffic that is associated with multiple modes of an application. For example, some applications may generate multiple types of uplink flows of data (for example, multiple modes). For example, an application (for example, an extended reality (XR) application or a virtual reality (VR) application) may generate audio data, video data, positioning data, haptic data, and/or other types of data that are each associated with the application. The different types of uplink flows may be associated with different QoS requirements. For example, video data may be associated with a high data rate, an average reliability requirement (e.g., 99%), and/or an average latency requirement (e.g., 50 milliseconds for uplink). Haptic data or control data may be associated with a low data rate, a high reliability requirement (e.g., 99.99%), and/or a stringent latency requirement (e.g., 20 milliseconds for uplink). The different types of uplink flows may be better served using different radio resources of a wireless network (for example, different TRPs, different RUs, or different network nodes 110). For example, a TRP or an RU deployed at or near a cell edge may enable improved coverage and throughput for UEs located at or near the cell edge. However, traffic routed through the TRP or RU at or near the cell edge may experience additional delays or latency (e.g., compared to traffic transmitted directly to a network node 110 or directly to a base station or DU, such as to a TRP or RU that is co-located with the base station or the DU). Therefore, traffic that has higher data rates and/or less latency sensitivity (e.g., video traffic) may be routed through the TRP or RU deployed at or near the cell edge (e.g., to achieve a higher throughput for the traffic). For other types of traffic that are less delay-sensitive, such as haptic data, control data, or other types of data, the traffic may be routed directly to a network node 110 (e.g., a base station or DU) to reduce the delay or latency.

As another example, TRPs or RUs serving respective carriers on different bands (such as in an inter-band carrier aggregation scenario) may not be co-located. For example, traffic for a given carrier may be routed to a network node (e.g., to a base station or a DU) via one or more midhaul links or one or more backhaul links. In such examples, different types of traffic may be routed to different carriers based on, or otherwise in accordance with, the QoS requirements of the different types of traffic.

In some examples, the network node 110 may determine a PBR for each LCH. The PBR may be a data rate provided to one LCH before allocating any resources to a lower priority LCH. For example, to avoid starvation of some LCHs (for example, to avoid scenarios in which a traffic for a given LCH is unable to be transmitted because higher priority LCHs have traffic that is filling the available resources), the PBR may set a limit for each LCH (e.g., each eligible LCH with a Bj parameter having a value greater than zero). For example, when filling the available resources, the PBR may indicate an amount of data that is to be added from each eligible LCH. If there are any remaining resources, then the available resources may be filled according to the priority of the LCHs (e.g., without limitation to LCHs with a Bj parameter having a value greater than zero).

In the second operation 610, the network node 110 may transmit the configuration information that indicates an LCH configuration for one or more LCHs. An LCH configuration may include a LogicalChannelConfig RRC parameter (for example, as defined, or otherwise fixed, by the 3GPP). The LCH configuration may indicate a priority (for example, an LCH priority), a PBR (for example, via a prioritisedBitRate IE), a BSD (for example, via a bucketSizeDuration IE), and/or other suitable parameters for the LCH associated with the LCH configuration. As described herein, the PBR and the BSD may define a “leaky-bucket regulator” for an LCH (e.g., where PBR×BSD defines a maximum bucket size that sets a maximum value for the Bj state variable used to determine eligible LCHs that have scheduling priority).

In a third operation 615, the network node 110 may transmit, and the UE 120, may receive, an uplink grant that indicates an uplink resource allocation for an uplink transmission by the UE 120. For example, in some aspects, the uplink resource allocation may indicate a TB size or other suitable parameters that define available radio resources for the uplink transmission (e.g., for a MAC PDU to carry data associated with one or more LCHs).

In a fourth operation 620, the UE 120 may select one or more LCHs for traffic to transmit to the network node 110. For example, different LCHs may be associated with different QoS requirements, as described above. In some examples, the UE 120 may select traffic associated with the one or more LCHs to fill available resources for an uplink transmission (for example, to fill a MAC PDU). The UE 120 may select the one or more LCHs based on, responsive to, or otherwise associated with priorities of respective LCHs that are associated with available uplink traffic to be transmitted.

For example, as shown in FIG. 6, an uplink buffer of the UE 120 may indicate that an LCH 1, an LCH 2, and an LCH 3 are associated with uplink traffic that is available to be transmitted. The LCH 1 may be associated with a priority 1 and a first PBR. The LCH 2 may be associated with a priority 2 (for example, indicating a lower priority than the priority 1) and a second PBR. The LCH 3 may be associated with a priority 3 (for example, indicating a lower priority than the priority 1 and the priority 2) and a third PBR.

In the fourth operation 620, the UE 120 may first select traffic from the LCH 1 to be included in the MAC PDU up to an amount of traffic indicated by the first PBR. The UE 120 may second select traffic from the LCH 2 to be included in the MAC PDU up to an amount of traffic indicated by the second PBR. The UE 120 may third select traffic from the LCH 3 to be included in the MAC PDU up to an amount of traffic indicated by the third PBR. As shown in FIG. 6, the LCH 3 may be associated with less traffic than the amount of traffic indicated by the third PBR, enabling the UE 120 to select all the traffic associated with the LCH 3. The UE 120 may fill any remaining space in the available resources (for example, in the MAC PDU) in accordance with the priorities of the LCHs. For example, the UE 120 may fourth fill the remaining space in the available resources (for example, in the MAC PDU) with traffic associated with the LCH 1 (for example, because the LCH 1 has the highest priority). If there are any remaining resources after adding the traffic associated with the LCH 1 to the MAC PDU, then the UE 120 may fill the remaining space in the available resources (for example, in the MAC PDU) with traffic associated with the LCH 2.

In a fifth operation 625, the UE 120 may transmit an uplink communication using the LCH(s). For example, the UE 120 may transmit the uplink communication via the available resources (for example, via the MAC PDU). The traffic (for example, data or control information) included in the uplink communication may be based on, responsive to, or otherwise associated with selection of the traffic in accordance with the LCH priorities (for example, as performed in the fourth operation 620).

As indicated above, FIG. 6 is provided as an example. Other examples may differ from what is described with regard to FIG. 6.

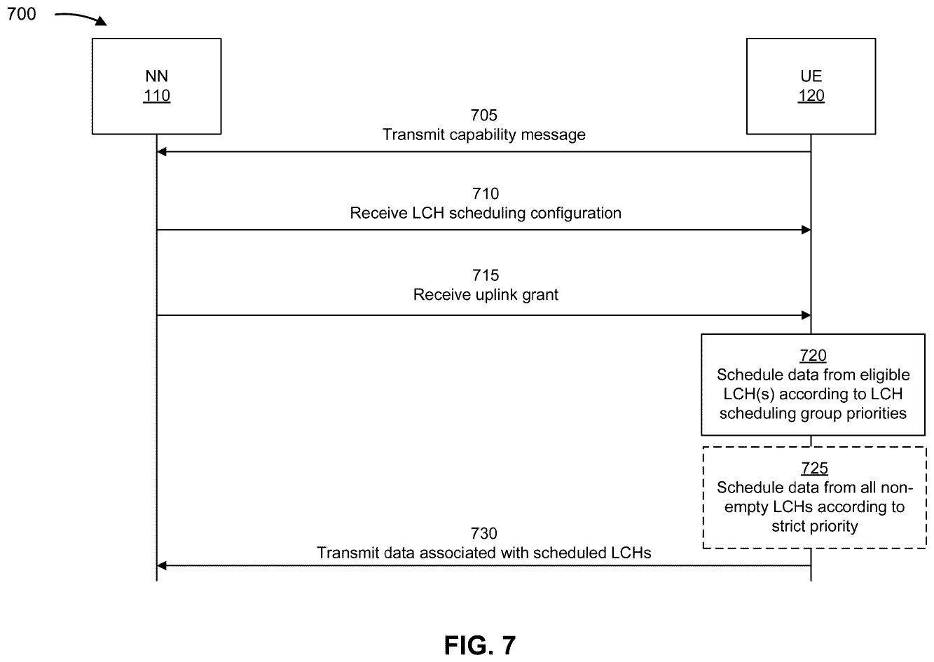

FIG. 7 is a diagram of an example 700 associated with LCH prioritization for LCH scheduling groups, in accordance with the present disclosure. As shown in FIG. 7, example 700 includes a UE (e.g., UE 120) and a network node (e.g., network node 110). The UE and the network node may be included in a wireless network, such as wireless network 100. The UE and the network node may communicate via a wireless access link, which includes an uplink and a downlink. The UE and the network node may have established a wireless connection prior to operations shown in FIG. 7.

As shown by reference number 705, the UE may transmit, and the network node may receive, a capability message. The capability message may indicate whether the UE supports a feature and/or one or more parameters related to LCH prioritization for scheduling groups. As another example, the capability message may indicate a capability and/or parameter for assigning LCHs to each scheduling group. For example, the capability and/or parameter may be associated with different flows (e.g., SRBs, delay-sensitive flows, eMBB flows, or the like), enabling the network node to assign LCHs to each scheduling group according to a scheduling group configuration for each scheduling group (e.g., a priority and/or a scheduling policy associated with each respective scheduling group). One or more operations described herein may be based on capability information of the capability message. For example, the UE may perform a communication in accordance with the capability information, or may receive configuration information that is in accordance with the capability information.

In some aspects, the network node may transmit, and the UE may receive, a request for the capability message. The UE may transmit, and the network node may receive, the capability message based on, in response to, or otherwise in association with the request.

As shown by reference number 710, the network node may transmit, and the UE may receive, an LCH scheduling configuration. In some aspects, the UE may receive the LCH scheduling configuration via one or more of RRC signaling, one or more MAC-CEs, and/or DCI, among other examples.

In some aspects, the LCH scheduling configuration may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the LCH scheduling configuration may indicate a set of parameters associated with one or more LCHs, where the parameters associated with each LCH may include a priority (e.g., an integer from 1 to 16 or another suitable value, where 1 corresponds to a highest priority and 16 corresponds to a lowest priority), a PBR (e.g., a value in kilobytes per second (KBps)), and a BSD (e.g., a value in milliseconds). Furthermore, as described herein, the LCH scheduling configuration may indicate one or more scheduling algorithms, such as FPQ, EDF, FCFS, or the like, to be used in an LCH prioritization procedure.

For example, the UE may prioritize scheduling data from the LCHs according to scheduling algorithms, including FPQ, EDF, FCFS, or the like. Each different scheduling algorithm may be well-suited for different contexts and applications. For example, the LCH scheduling configuration may indicate different scheduling algorithms to different LCH scheduling groups and between different LCH scheduling groups depending on the context, application, key performance parameters, or other criteria associated with the LCHs assigned to an LCH scheduling group. In an EDF scheduling algorithm, for example, LCHs may be sorted by hard deadlines and prioritization may be enforced according to the hard deadlines when a link is not overloaded. Accordingly, the deadline directly determines priority, reliability, or the like. In an FPQ scheduling algorithm, for example, bandwidth may be allocated among different flows based upon the priority and PBR for each flow. However, high-priority flows may cause starvation of low priority flows when traffic for a given LCH is unable to be transmitted because higher priority LCHs have traffic that is filling the available resources. In a FCFS scheduling algorithm, for example, flows are transmitted in the order of their arrival, enabling a low-complexity data flow that is suitable for data with a small size and/or no hard deadlines. However, FCFS scheduling may lead to potential long queueing and wait times where the scheduling does not consider priority, deadline, data volume, or the like.

In some aspects, the LCH scheduling configuration may configure multiple scheduling groups that each include one or more LCHs. For example, different types of LCHs may be assigned to different scheduling groups, where each scheduling group may include one or more LCHs having a defined LCH type or other similar parameters (e.g., delay requirements, QoS requirements, burst sizes, or the like). In some aspects, a scheduling group as described herein may be the same as or different from an LCH group utilized in a BSR procedure to provide the network node 110 with information regarding UL data volume in a MAC entity associated with the UE.

In some aspects, each scheduling group may be configured with a respective intra-group scheduling policy. For example, the LCH scheduling configuration may indicate an intra-group scheduling algorithm (e.g., EDF, FPQ, FCFS, or the like) to schedule data associated with LCHs within each scheduling group. Additionally or alternatively, multiple scheduling groups may be configured with the same intra-group scheduling policy.

In an EDF scheduling algorithm, for example, LCHs may be sorted by hard deadlines and prioritization may be enforced when a link is not overloaded. Accordingly, the deadline directly determines priority, reliability, or the like. However, EDF scheduling may not perform well in a congested, high-traffic environment, where EDF scheduling requires sorting of all flows by priority (e.g., based on deadlines). This approach may prove resource intensive when a large number of flows are present. In an FPQ scheduling algorithm, for example, bandwidth may be allocated among different flows based upon a priority and PBR associated with each flow. However, high-priority flows may cause starvation of low priority flows when traffic for a given LCH is unable to be transmitted because higher priority LCHs have traffic that is filling the available resources. In an FCFS scheduling algorithm, for example, flows are transmitted in the order of their arrival. However, FCFS scheduling does not consider priority, deadline, data volume, or the like, leading to potentially long queueing and waiting times.

In some aspects, FCFS scheduling may be appropriate for a scheduling group including flows of high importance and that must be scheduled first. Similarly, EDF scheduling may be appropriate for a scheduling group including flows that are delay-sensitive but may not need to be scheduled with the FCFS-scheduled flows. Additionally, FPQ scheduling may be appropriate for a scheduling group including all other flows that are not delay-sensitive and may not need to be scheduling with the FCFS-scheduled flows For example, in a configuration including three scheduling groups (referred to as scheduling group A, scheduling group B, and scheduling group C), the LCH scheduling configuration may assign SRBs to scheduling group A with FCFS as an intra-group scheduling policy (e.g., because signaling data is of high importance and because the data size of SRBs are generally not large enough to fill available resources), assign all delay-sensitive flows to scheduling group B with EDF as an intra-group scheduling policy (e.g., because EDF scheduling may enforce hard deadlines efficiently when there are a relatively small number of delay-sensitive flows), and/or may assign all other eMBB-type flows to scheduling group C with FPQ as an intra-group scheduling policy (e.g., because FPQ provides a straightforward prioritization among different flows and provides a fair allocation of bandwidth among different flows based on priority and PBR).

In some aspects, the LCH scheduling configuration may configure priorities for different scheduling groups, where priority can be determined by one or more parameters. For example, the priority of a scheduling group may be determined according to the highest priority of an LCH within the scheduling group. The UE may utilize this priority information when determining priority as between scheduling groups according to the LCH scheduling configuration (e.g., according to an inter-group scheduling policy, such as FPQ or another suitable policy).

In some aspects, the LCH scheduling configuration may indicate that the UE is to schedule LCH transmissions according to an LCH scheduling configuration, where the LCH scheduling configuration includes at least one intra-group priority policy applied to the scheduling groups. Similarly, in some aspects, the LCH scheduling configuration may configure at least one inter-group priority policy used to prioritize between scheduling groups.

The UE may configure itself based at least in part on the LCH scheduling configuration. In some aspects, the UE may be configured to perform one or more operations described herein based at least in part on the LCH scheduling configuration.

As shown by reference number 715, the network node 110 may transmit, and the UE 120 may receive, an uplink grant that indicates an uplink resource allocation. For example, in some aspects, the uplink resource allocation may indicate an amount of UL-SCH resources, a size for a MAC PDU, an amount of radio resources, and/or other suitable information that defines an allocated size for an uplink transmission.

As shown by reference number 720, the UE may schedule LCH transmissions according to the LCH scheduling configuration and the uplink resource allocation.

In some aspects, the UE may prioritize the scheduling groups according to an inter-group priority policy applied to all or to a subset of scheduling groups, and the UE may prioritize the set of LCHs within each scheduling group according to an intra-group priority policy associated with each scheduling group. For example, each scheduling group may be configured with the same intra-group scheduling policy. Alternatively, each scheduling group or a subset of scheduling groups may be configured with a different intra-group scheduling policy. In some aspects, the inter-group priority policy may be different than the intra-group priority policy. In some aspects, the inter-group priority policy may be the same as one or more intra-group priority policies.

In some aspects, the UE may prioritize scheduling groups having the highest priority according to an inter-group scheduling policy. For example, if the highest priority scheduling group has at least one eligible LCH (e.g., an LCH satisfying a scheduling condition, such as an LCH having a Bj value greater than 0, or the like), the LCHs of the highest priority scheduling group may be scheduled according to an intra-group scheduling policy. In some aspects, if two or more PDUs associated with the scheduling group having the highest priority have the same deadline, the PDU with the higher priority may be scheduled first if an EDF intra-group scheduling policy is configured. Alternatively, if a different intra-group priority policy is configured, a different PDU may be scheduled. For example, if an FCFS intra-group scheduling policy is configured, PDUs are scheduled based on the order in which the PDUs arrived in a buffer. In some aspects, eligible LCHs of the highest priority scheduling group may be scheduled until there are no additional eligible LCHs in the scheduling group or until the TB is full.

In some aspects, where the TB has available capacity after scheduling eligible LCHs of the highest priority scheduling group, the UE may schedule LCHs in the scheduling group having the next highest priority according to an intra-group scheduling policy (e.g., until there are no additional eligible LCHs in the scheduling group with the next highest priority or the TB is full).

As shown by reference number 725, in some aspects, the UE may schedule all non-empty LCHs, across all scheduling groups, according to an inter-group priority policy based on the TB having available capacity after the UE schedules all eligible LCHs according to the intra-group priority policies. For example, the inter-group priority policy may be a strict priority policy. For example, if the TB is not full following the scheduling of eligible LCHs according to the intra-group priority policies, the UE may perform strict priority scheduling among all non-empty LCHs until either all data from LCHs has been included in the TB or the TB is full.

As shown by reference number 730, the UE may transmit scheduled LCHs according to the scheduling results of reference number 720.

As described herein, LCH prioritization using multiple scheduling policies applied between scheduling groups and within scheduling groups, according to some aspects described here, provides better support for delay-sensitive traffic and low latency applications. For example, different scheduling algorithms may be used for intra-group priority policies and/or for inter-group priority policies depending on the LCH type(s) and/or the network application. For example, EDF can be used to enforce hard deadlines when a link is not overloaded or when there are a small number of flows in a group. Similarly, FPQ can be used to simplify priority scheduling by avoiding the resource-intensive process of sorting a large number of flows by respective deadlines. For example, FPQ may be used as an inter-group scheduling policy and EDF may be used as an intra-group scheduling policy, resulting in efficient sorting of priority between LCH scheduling groups and accurate enforcement of hard deadlines between LCHs in each scheduling group.

As indicated above, FIG. 7 is provided as an example. Other examples may differ from what is described with respect to FIG. 7.

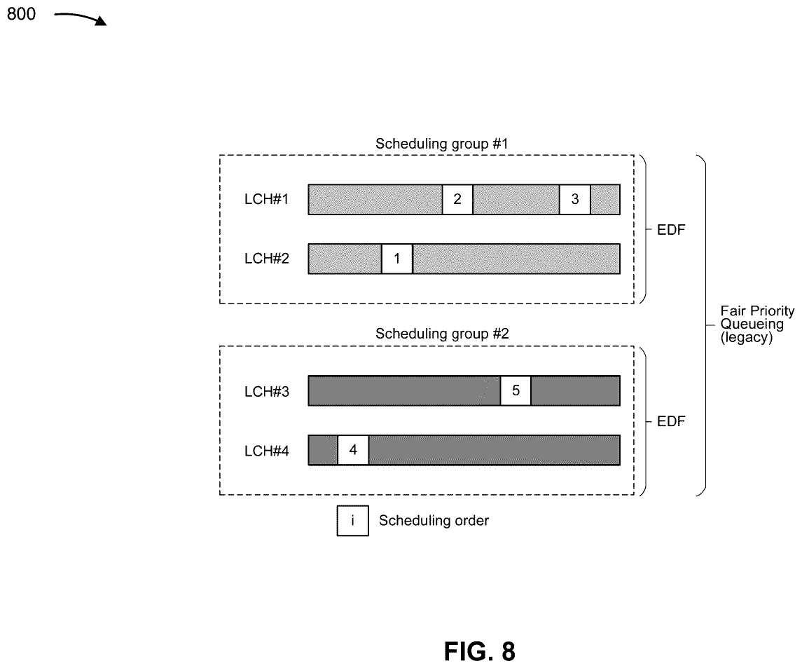

FIG. 8 is a diagram illustrating an example aspect 800 associated with scheduling groups for LCH prioritization, in accordance with the present disclosure.

In some aspects, an LCH scheduling configuration may configure LCHs to be assigned to different scheduling groups (e.g., scheduling groups may include LCHs of a defined LCH type). For example, a scheduling group #1 is illustrated as including LCH #1 and LCH #2 and a scheduling group #2 is illustrated as including LCH #3 and LCH #4.

Furthermore, an LCH scheduling configuration may assign an intra-group priority policy to each scheduling group and an inter-group priority policy to all and/or a subset of scheduling groups. For example, scheduling group #1 and scheduling group #2 are shown as having an EDF intra-group priority policy applied to each of these scheduling groups. Similarly, an FPQ inter-group priority policy is applied to determine priority between scheduling group #1 and scheduling group #2. In some aspects, multiple scheduling algorithms may be integrated to schedule priority among LCHs and among scheduling groups. Additionally or alternatively, the same scheduling algorithm may be used in an inter-group priority policy and in one or more intra-group priority policies.

In some aspects, the scheduling of LCH transmissions may occur in two phases (e.g., phase 1 and phase 2). In phase 1, LCHs of the scheduling group with the highest priority, as determined, for example, by an inter-group priority policy, may be scheduled first. As shown in FIG. 8, because scheduling group #1 has a highest priority according to an FPQ inter-group priority policy, scheduling group #1 may be scheduled first. If scheduling group #1 has at least one eligible LCH (e.g., at least one LCH satisfies a priority threshold, has a Bj value greater than 0, satisfies any applicable LCH restrictions, or the like), then all eligible LCHs in scheduling group #1 may be scheduled based on an EDF policy. For example, PDUs within an eligible LCH may be scheduled according to the priority of a scheduling order for the PDUs. In some aspects, if two PDUs have the same deadline and the EDF policy is configured for the scheduling group, the PDU with a higher priority may be scheduled first. In a scenario where scheduling group #1 includes no additional eligible LCHs and the TB is not filled, then all eligible LCHs in scheduling group #2 may be scheduled based on an EDF policy (or another intra-group priority policy that may be configured). This process may continue until no scheduling group includes any remaining eligible LCHs or until the TB is filled. For example, if the TB is filled, no additional scheduling may be performed until the UE receives an additional UL grant.

In phase 2 of the procedure, and if the TB is not filled after completion of phase 1, strict priority scheduling (or another inter-group priority policy that may be configured) may be performed among all non-empty LCHs until either all data has been included in the TB or the TB is full.

In some aspects, scheduling within an LCH may be performed using a scheduling configuration based on a leaky bucket regulator (e.g., based on a PBR, BSD, priority, or the like). In some aspects, scheduling policies based on leaky bucket regulator techniques or other suitable techniques may be implemented through the LCH scheduling configuration. For example, if a scheduling group includes only one LCH (e.g., the LCH, alone, is a scheduling group), then a scheduling policy based on a leaky bucket regulator may be applied to this scheduling group.

As described herein, LCH prioritization using multiple scheduling policies applied between scheduling groups and within scheduling groups, according to some aspects described here, provides better support for delay-sensitive traffic and low latency applications. By sorting LCHs into scheduling groups according to LCH type, delay-sensitive traffic can be efficiently prioritized and scheduled to optimize latency and throughput.

As indicated above, FIG. 8 is provided as an example. Other examples may differ from what is described with respect to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with scheduling groups for LCH prioritization.

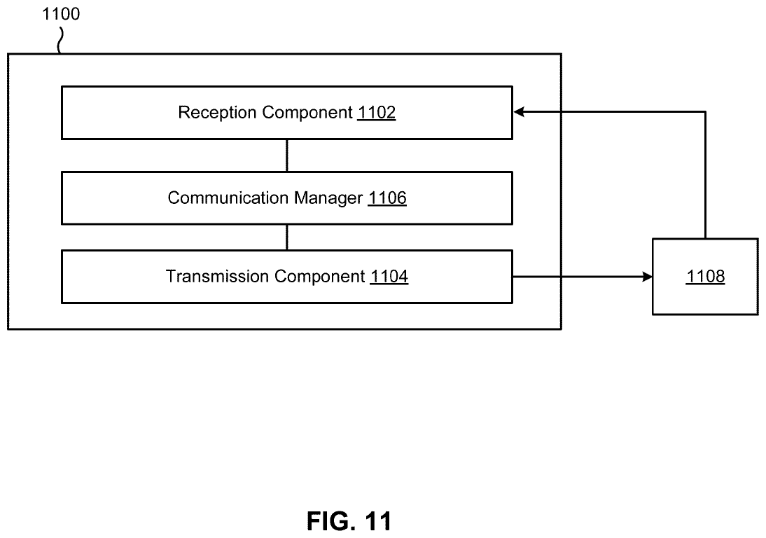

As shown in FIG. 9, in some aspects, process 900 may include receiving a scheduling configuration associated with a plurality of LCH scheduling groups (block 910). For example, the UE (e.g., using reception component 1102 and/or communication manager 1106, depicted in FIG. 11) may receive a scheduling configuration associated with a plurality of LCH scheduling groups, as described above.

As further shown in FIG. 9, in some aspects, process 900 may include transmitting data from at least one LCH in an LCH scheduling group, of the plurality of LCH scheduling groups, according to a priority policy that the scheduling configuration indicates for the at least one LCH scheduling group (block 920). For example, the UE (e.g., using transmission component 1104 and/or communication manager 1106, depicted in FIG. 11) may transmit data from at least one LCH in an LCH scheduling group, of the plurality of LCH scheduling groups, according to a priority policy that the scheduling configuration indicates for the at least one LCH scheduling group, as described above.

Process 900 may include additional aspects, such as any single aspect or any combination of aspects described below and/or in connection with one or more other processes described elsewhere herein.

In a first aspect, process 900 includes prioritizing the plurality of LCH scheduling groups according to an inter-group priority policy, and prioritizing a set of LCHs within each LCH scheduling group according to an intra-group priority policy associated with each LCH scheduling group.

In a second aspect, alone or in combination with the first aspect, process 900 includes scheduling LCHs within at least two LCH scheduling groups, of the plurality of LCH scheduling groups, according to the respective intra-group priority policy applied to each of the at least two LCH scheduling groups, and scheduling LCHs across the at least two LCH scheduling groups according to the inter-group priority policy applied to the plurality of LCH scheduling groups.

In a third aspect, alone or in combination with one or more of the first and second aspects, process 900 includes scheduling LCHs within the at least two LCH scheduling groups according to a strict priority policy based on each of the at least two LCH scheduling groups including no LCHs that satisfy a prioritized scheduling condition after the scheduling of the LCHs based on the intra-group priority policy.

In a fourth aspect, alone or in combination with one or more of the first through third aspects, process 900 includes scheduling LCHs within the at least two LCH scheduling groups according to a strict priority policy based on a transport block (TB) having available capacity after the scheduling of the LCHs based on the intra-group priority policy.

In a fifth aspect, alone or in combination with one or more of the first through fourth aspects, the scheduling configuration indicates a priority for each LCH scheduling group based on a highest LCH priority associated with one or more LCHs in the respective LCH scheduling group.

In a sixth aspect, alone or in combination with one or more of the first through fifth aspects, the inter-group priority policy is different from the intra-group priority policy.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with scheduling groups for LCH prioritization.

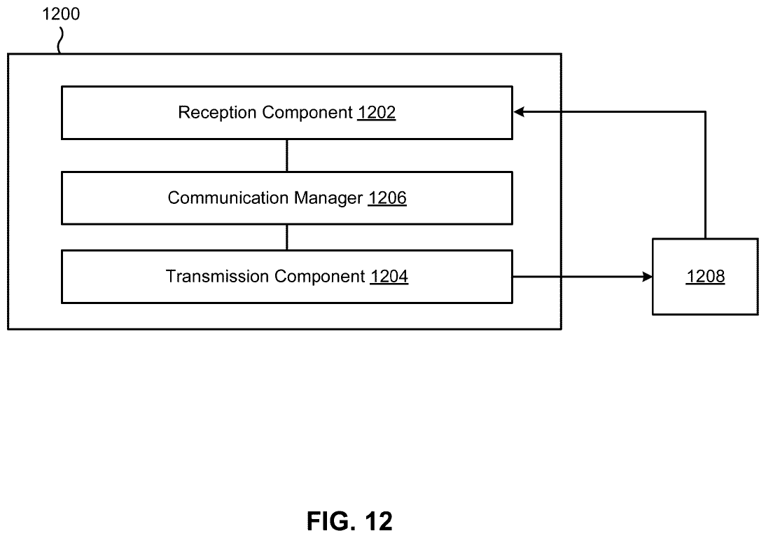

As shown in FIG. 10, in some aspects, process 1000 may include transmitting a scheduling configuration associated with a plurality of LCH scheduling groups (block 1010). For example, the network node (e.g., using transmission component 1204 and/or communication manager 1206, depicted in FIG. 12) may transmit a scheduling configuration associated with a plurality of LCH scheduling groups, as described above.

As further shown in FIG. 10, in some aspects, process 1000 may include receiving data from at least one LCH in an LCH scheduling group, of the plurality of LCH scheduling groups, according to a priority policy that the scheduling configuration indicates for the at least one LCH scheduling group (block 1020). For example, the network node (e.g., using reception component 1202 and/or communication manager 1206, depicted in FIG. 12) may receive data from at least one LCH in an LCH scheduling group, of the plurality of LCH scheduling groups, according to a priority policy that the scheduling configuration indicates for the at least one LCH scheduling group, as described above.

Process 1000 may include additional aspects, such as any single aspect or any combination of aspects described below and/or in connection with one or more other processes described elsewhere herein.

In a first aspect, process 1000 includes prioritizing the plurality of LCH scheduling groups according to an inter-group priority policy, and prioritizing a set of LCHs within each LCH scheduling group according to an intra-group priority policy associated with each LCH scheduling group.

In a second aspect, alone or in combination with the first aspect, process 1000 includes scheduling LCHs within at least two LCH scheduling groups, of the plurality of LCH scheduling groups, according to the respective intra-group priority policy applied to each of the at least two LCH scheduling groups, and scheduling LCHs across the at least two LCH scheduling groups according to the inter-group priority policy applied to the plurality of LCH scheduling groups.

In a third aspect, alone or in combination with one or more of the first and second aspects, each LCH scheduling group is associated with a LCH type.

In a fourth aspect, alone or in combination with one or more of the first through third aspects, an LCH scheduling group including only one LCH is associated with a default scheduling.

In a fifth aspect, alone or in combination with one or more of the first through fourth aspects, the priority policy includes at least one of an FCFS algorithm, an FPQ algorithm, or an EDF algorithm.

In a sixth aspect, alone or in combination with one or more of the first through fifth aspects, the data is transmitted from the at least one LCH based on the LCH scheduling group associated with the at least one LCH scheduling group being associated with a scheduling state variable value having a value that satisfies a threshold.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 7-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 1 and FIG. 2. Additionally, or alternatively, one or more components shown in FIG. 11 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a scheduling configuration associated with a plurality of LCH scheduling groups. The transmission component 1104 may transmit data from at least one LCH in an LCH scheduling group, of the plurality of LCH scheduling groups, according to a priority policy that the scheduling configuration indicates for the at least one LCH scheduling group.

The communication manager 1106 may prioritize the plurality of LCH scheduling groups according to an inter-group priority policy. The communication manager 1106 may prioritize a set of LCHs within each LCH scheduling group according to an intra-group priority policy associated with each LCH scheduling group.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 7-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 1 and FIG. 2. Additionally, or alternatively, one or more components shown in FIG. 12 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit a scheduling configuration associated with a plurality of LCH scheduling groups. The reception component 1202 may receive data from at least one LCH in an LCH scheduling group, of the plurality of LCH scheduling groups, according to a priority policy that the scheduling configuration indicates for the at least one LCH scheduling group.

The communication manager 1206 may prioritize the plurality of LCH scheduling groups according to an inter-group priority policy. The communication manager 1206 may prioritize a set of LCHs within each LCH scheduling group according to an intra-group priority policy associated with each LCH scheduling group.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving a scheduling configuration associated with a plurality of logical channel (LCH) scheduling groups; and transmitting data from at least one LCH in an LCH scheduling group, of the plurality of LCH scheduling groups, according to a priority policy that the scheduling configuration indicates for the at least one LCH scheduling group.

Aspect 2: The method of Aspect 1, further comprising: prioritizing the plurality of LCH scheduling groups according to an inter-group priority policy; and prioritizing a set of LCHs within each LCH scheduling group according to an intra-group priority policy associated with each LCH scheduling group.

Aspect 3: The method of Aspect 2, further comprising: scheduling LCHs within at least two LCH scheduling groups, of the plurality of LCH scheduling groups, according to the respective intra-group priority policy applied to each of the at least two LCH scheduling groups; and scheduling LCHs across the at least two LCH scheduling groups according to the inter-group priority policy applied to the plurality of LCH scheduling groups.

Aspect 4: The method of Aspect 3, further comprising: scheduling LCHs within the at least two LCH scheduling groups according to a strict priority policy based on each of the at least two LCH scheduling groups including no LCHs that satisfy a prioritized scheduling condition after the scheduling of the LCHs based on the intra-group priority policy.

Aspect 5: The method of Aspect 3, further comprising: scheduling LCHs within the at least two LCH scheduling groups according to a strict priority policy based on a transport block (TB) having available capacity after the scheduling of the LCHs based on the intra-group priority policy.

Aspect 6: The method of Aspect 2, wherein the scheduling configuration indicates a priority for each LCH scheduling group based on a highest LCH priority associated with one or more LCHs in the respective LCH scheduling group.

Aspect 7: The method of Aspect 2, wherein the inter-group priority policy is different from the intra-group priority policy.

Aspect 8: A method of wireless communication performed by a network node, comprising: transmitting a scheduling configuration associated with a plurality of logical channel (LCH) scheduling groups; and receiving data from at least one LCH in an LCH scheduling group, of the plurality of LCH scheduling groups, according to a priority policy that the scheduling configuration indicates for the at least one LCH scheduling group.

Aspect 9: The method of Aspect 8, further comprising: prioritizing the plurality of LCH scheduling groups according to an inter-group priority policy; and prioritizing a set of LCHs within each LCH scheduling group according to an intra-group priority policy associated with each LCH scheduling group.

Aspect 10: The method of Aspect 9, further comprising: scheduling LCHs within at least two LCH scheduling groups, of the plurality of LCH scheduling groups, according to the respective intra-group priority policy applied to each of the at least two LCH scheduling groups; and scheduling LCHs across the at least two LCH scheduling groups according to the inter-group priority policy applied to the plurality of LCH scheduling groups.

Aspect 11: The method of any of Aspects 8-10, wherein each LCH scheduling group is associated with a LCH type.

Aspect 12: The method of any of Aspects 8-11, wherein an LCH scheduling group including only one LCH is associated with a default scheduling.

Aspect 13: The method of any of Aspects 8-12, wherein the priority policy includes at least one of a first come first serve (FCFS) algorithm, a fair priority queueing (FPQ) algorithm, or an earliest deadline first (EDF) algorithm.

Aspect 14: The method of any of Aspects 8-13, wherein the data is transmitted from the at least one LCH based on the LCH scheduling group associated with the at least one LCH scheduling group being associated with a scheduling state variable value having a value that satisfies a threshold.

Aspect 15: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-14.

Aspect 16: An apparatus for wireless communication at a device, the apparatus comprising one or more memories and one or more processors coupled to the one or more memories, the one or more processors configured to cause the device to perform the method of one or more of Aspects 1-14.

Aspect 17: An apparatus for wireless communication, the apparatus comprising at least one means for performing the method of one or more of Aspects 1-14.

Aspect 18: A non-transitory computer-readable medium storing code for wireless communication, the code comprising instructions executable by one or more processors to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

Aspect 20: A device for wireless communication, the device comprising a processing system that includes one or more processors and one or more memories coupled with the one or more processors, the processing system configured to cause the device to perform the method of one or more of Aspects 1-14.

Aspect 21: An apparatus for wireless communication at a device, the apparatus comprising one or more memories and one or more processors coupled to the one or more memories, the one or more processors individually or collectively configured to cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication, comprising:
one or more memories; and
one or more processors coupled to the one or more memories, the one or more processors individually or collectively configured to:
receive a scheduling configuration associated with a plurality of logical channel (LCH) scheduling groups; and
transmit data from at least one LCH in an LCH scheduling group, of the plurality of LCH scheduling groups, according to a priority policy that the scheduling configuration indicates for the at least one LCH scheduling group.

2. The apparatus of claim 1, wherein the one or more processors are further configured to:
prioritize the plurality of LCH scheduling groups according to an inter-group priority policy; and
prioritize a set of LCHs within each LCH scheduling group according to an intra-group priority policy associated with each LCH scheduling group.

3. The apparatus of claim 2, wherein the one or more processors are further configured to:
schedule LCHs within at least two LCH scheduling groups, of the plurality of LCH scheduling groups, according to the respective intra-group priority policy applied to each of the at least two LCH scheduling groups; and
schedule LCHs across the at least two LCH scheduling groups according to the inter-group priority policy applied to the plurality of LCH scheduling groups.

4. The apparatus of claim 3, wherein the one or more processors are further configured to:
schedule LCHs within the at least two LCH scheduling groups according to a strict priority policy based on each of the at least two LCH scheduling groups including no LCHs that satisfy a prioritized scheduling condition after the scheduling of the LCHs based on the intra-group priority policy.

5. The apparatus of claim 3, wherein the one or more processors are further configured to:
schedule LCHs within the at least two LCH scheduling groups according to a strict priority policy based on a transport block (TB) having available capacity after the scheduling of the LCHs based on the intra-group priority policy.

6. The apparatus of claim 2, wherein the scheduling configuration indicates a priority for each LCH scheduling group based on a highest LCH priority associated with one or more LCHs in the respective LCH scheduling group.

7. The apparatus of claim 2, wherein the inter-group priority policy is different from the intra-group priority policy.

8. An apparatus for wireless communication, comprising:
one or more memories; and
one or more processors coupled to the one or more memories, the one or more processors individually or collectively configured to:
transmit a scheduling configuration associated with a plurality of logical channel (LCH) scheduling groups; and
receive data from at least one LCH in an LCH scheduling group, of the plurality of LCH scheduling groups, according to a priority policy that the scheduling configuration indicates for the at least one LCH scheduling group.

9. The apparatus of claim 8, wherein the one or more processors are further configured to:
prioritize the plurality of LCH scheduling groups according to an inter-group priority policy; and
prioritize a set of LCHs within each LCH scheduling group according to an intra-group priority policy associated with each LCH scheduling group.

10. The apparatus of claim 9, wherein the one or more processors are further configured to:
schedule LCHs within at least two LCH scheduling groups, of the plurality of LCH scheduling groups, according to the respective intra-group priority policy applied to each of the at least two LCH scheduling groups; and
schedule LCHs across the at least two LCH scheduling groups according to the inter-group priority policy applied to the plurality of LCH scheduling groups.

11. The apparatus of claim 8, wherein each LCH scheduling group is associated with a LCH type.

12. The apparatus of claim 8, wherein an LCH scheduling group including only one LCH is associated with a default scheduling.

13. The apparatus of claim 8, wherein the priority policy includes at least one of a first come first serve (FCFS) algorithm, a fair priority queueing (FPQ) algorithm, or an earliest deadline first (EDF) algorithm.

14. The apparatus of claim 8, wherein the data is transmitted from the at least one LCH based on the LCH scheduling group associated with the at least one LCH scheduling group being associated with a scheduling state variable value having a value that satisfies a threshold.

15. A method of wireless communication performed by a user equipment (UE), comprising:
receiving a scheduling configuration associated with a plurality of logical channel (LCH) scheduling groups; and
transmitting data from at least one LCH in an LCH scheduling group, of the plurality of LCH scheduling groups, according to a priority policy that the scheduling configuration indicates for the at least one LCH scheduling group.

16. The method of claim 15, further comprising:
prioritizing the plurality of LCH scheduling groups according to an inter-group priority policy; and
prioritizing a set of LCHs within each LCH scheduling group according to an intra-group priority policy associated with each LCH scheduling group.

17. The method of claim 16, further comprising:
scheduling LCHs within at least two LCH scheduling groups, of the plurality of LCH scheduling groups, according to the respective intra-group priority policy applied to each of the at least two LCH scheduling groups; and
scheduling LCHs across the at least two LCH scheduling groups according to the inter-group priority policy applied to the plurality of LCH scheduling groups.

18. The method of claim 17, further comprising:
scheduling LCHs within the at least two LCH scheduling groups according to a strict priority policy based on each of the at least two LCH scheduling groups including no LCHs that satisfy a prioritized scheduling condition after the scheduling of the LCHs based on the intra-group priority policy.

19. The method of claim 17, further comprising:
scheduling LCHs within the at least two LCH scheduling groups according to a strict priority policy based on a transport block (TB) having available capacity after the scheduling of the LCHs based on the intra-group priority policy.

20. The method of claim 16, wherein the scheduling configuration indicates a priority for each LCH scheduling group based on a highest LCH priority associated with one or more LCHs in the respective LCH scheduling group.
